(19) United States
(12) Patent Application Publication
(10) Pub. No.: US 2010/0064279 A1
(43) Pub. Date: Mar. 11, 2010

(54) Instrumentation for Real-Time Performance Profiling

(75) Inventor: Neil Stewart, Glasgow (GB)

Correspondence Address: CHOATE, HALL & STEWART LLP, TWO INTERNATIONAL PLACE, BOSTON, MA, 02110, US

(73) Assignee: SLAM GAMES LIMITED, Glasgow, GB (GB)

(21) Appl. No.: 12/282,499

(22) PCT Filed: Mar. 12, 2007
(86) PCT No.: PCT/GB2007/000855

§ 371 Date: Jan. 22, 2009

(30) Foreign Application Priority Data
Mar. 11, 2006 (GB) 0604991.0

(51) Int. Cl. G06F 9/44; G06F 11/36

(52) U.S. Cl. 717/122; 717/120; 717/124

(57) ABSTRACT

A method of source code instrumentation for computer program performance profiling includes generating (14) and inserting (19) instrumentation code around a call site of a child function in a parent function. The instrumentation code may use a reference to an unique instrumentation record (13), such as a timing record. The instrumentation code may be optimised (15) to use the exit time of a preceding call site in the parent function as the entry time of the call site. It may be inserted depending on the level in the call hierarchy of the child function and its execution at run time may depend on the state of an enable flag, which can be set via a viewing interface. Two versions of the child function may be generated (18), one being instrumented and other being non-instrumented and which one is run depends on the enable flag.

The present invention relates to computer program performance profiling, in particular instrumentation of computer programs for performance profiling.

In the field of computer program performance profiling, instrumentation of functions is used to measure and record performance information, such as time spent executing the functions. However, the instrumentation has a performance impact on the program being profiled.

In order to reduce the performance impact, many profiling tools operate in a non-real-time manner, where the timings are gathered in one step and then displayed in a separate step. For certain program types, this is sufficient, but since game performance profiles tend to change over time and the notion of “frame time” is very important for achieving consistent frame-rates, real-time profilers that can display timings while the game is running is far more useful to game developers.

Another issue with existing profilers is that they have to make various accuracy/completeness trade-offs, and the user doesn't always have the ability to adjust the trade-offs being made, meaning that most solutions leave the developer with—at best—a partial picture of their game's performance profile.

Existing profiling tools can be broken down into roughly two main types:
Instrumenting profilers.
Sampling profilers.

The limitations of these will be briefly discussed below.

An instrumenting profiler operates by injecting timing routines into a program's code at the start and end of each function. The routine added to the start of each function logs an entry time and the routine added to the end logs an exit time.

In simple terms, time spent in each function is then calculated as the exit time minus the entry time.

Most instrumenting profilers use binary instrumentation, where the program's compiled object files are modified directly. Unfortunately, this limits the deployment of such profilers to the systems for which the binary instrumentation system has been designed, which eliminates almost all existing binary instrumenting profilers from game console use.

The alternative to binary instrumentation is to use source code instrumentation, where the program's source code is modified on-the-fly before being handed to the compiler. This allows the profiler to be easily deployed on any platform.

As well as being capable of achieving very accurate results for most programs, instrumenting profilers are also capable of capturing the program's call graph, which shows a hierarchical view of all the function calls made in a program.

This call graph can give developers a very complete picture of where all the time is spent in a program, and at many different levels of detail. For any given function, the developer can determine which functions called it (and how many times and how long it took for each), and which functions it called (and how many times and how long it spent in each).

This kind of information is critical to determining where to concentrate the most optimisation effort. Say, for example, that the profiler shows that the program spends 40% of its time in function f. At first glance, it may appear that the developer should expend most of his effort optimising f. However, if the developer looks at the call graph, he may realise that f is actually very fast, but it is being called an extremely large number of times. He may then decide that his effort is best spent reducing the number of times it is called, if possible.

The timing routines have to do the following at run time:
Obtain the current time.
Determine which parent function called the current function.
Create/find a storage slot which is unique to this combination of function and parent function.

A problem with instrumenting profilers is that the addition of such complex timing routines in every function places a significant extra processing load on the program at run time, which causes the program to run several times slower in most cases. For many applications, this is not a major issue, but it is quite a serious problem for games for two reasons:

1) Interactivity—If the profiling routines slow the game down too much, it may become impossible to play, which may make it difficult or impossible to profile successfully. This also tends to preclude any form of real-time timing results.

2) Asynchronous hardware—Although the profiler will cause the program code to run slower, asynchronous hardware (e.g. GPU) will continue to run at its normal speed. This will give the impression that this hardware is relatively much faster than it really is, which can significantly skew the timing results and confuse the developer.

An alternative to an instrumenting profiler is the sampling profiler. A sampling profiler operates by running a high-resolution timer which makes repeated callbacks to a timing routine. These callbacks interrupt the main program.

When called, the timing routine determines which function/thread/process it just interrupted, and logs a sample hit for that function (and thread/process). When the sampling period is complete, the profiler uses these hit counts to determine which proportion of the program's time was spent in each function (and thread/process).

The main advantage of sampling profilers is that they tend to impact the performance of the program much less than instrumenting profilers, thus reducing the problems associated with interactivity and asynchronous hardware that plague instrumenting profilers.

However, one fundamental problem with sampling profilers is that the accuracy of the timings is dependent on the frequency of the callback timer: if the frequency is too low, then smaller functions will tend to be counted less, and may even be missed entirely. Unfortunately, if the timer frequency is increased too much, performance will start to drop towards that of an instrumenting profiler, thus eliminating the sampling profiler's main advantage over instrumenting profilers.

Unfortunately, this is not the only fundamental problem with sampling profilers. The other major issue with them is that they cannot easily and/or accurately capture a program's call graph information, certainly not without significantly hampering the performance gains they have over instrumenting profilers.

It is an object of an aspect of the present invention to reduce the impact of instrumentation on the computer program being instrumented.

According to a first aspect of the present invention, there is provided a method of instrumentation of a child function in a computer program, wherein the child function is called by a parent function, the method comprising the step of inserting instrumentation code around a call site of the child function in the parent function.

Therefore the instrumentation code captures the time taken to actually call the child function.

Preferably, the method further comprises the steps of:
determining a reference to an instrumentation record unique to the combination of the call site and the child function; and
configuring the instrumentation code to use the reference for the instrumentation of the child function.

Preferably, the reference refers to the location of an instrumentation record in a table.

Preferably the instrumentation record comprises a timing record.

Therefore, the run-time performance of the profiling is improved because there is now no requirement in the child function to determine the reference to the timing slot for that combination of parent and child function.

Preferably, the method further comprises the step of optimising the instrumentation code to use the exit time of a preceding call site in the parent function as the entry time of the call site.

Therefore, the relatively expensive operation of obtaining the system clock value may be eliminated between chained calls, which decreases the instrumentation performance overhead.

Preferably, the method further comprises the step of inserting the instrumentation code depending on the level in the call hierarchy of the child function.

Therefore, functions can be instrumented or not selectively depending on their level in the hierarchy of function calls. Also, a particular child function may be called with or without instrumentation at run time, depending where in the hierarchy it is called from.

Preferably, the method further comprises the step of configuring the instrumentation code such that its execution at run time of the computer program depends on the state of an enable flag.

Therefore, the instrumentation can be switched on or off dynamically at run time, globally or for particular functions.

Preferably, the method further comprises the step of generating two versions of the child function, one being instrumented and other being non-instrumented.

Preferably the step of configuring the instrumentation code such that its execution at run time of the computer program depends on the status of an enable flag further comprises the step of configuring the instrumentation code to call either the instrumented version of the child function, depending on the state of the enable flag.

Preferably, the method further comprises the steps of:
configuring a viewing interface to view results of the instrumentation of the computer program; and
setting the enable flag in response to the state of the viewing interface.

Therefore, the instrumentation can be switched on dynamically at run time only for the levels and groups of functions which are being inspected at run time, thereby decreasing the profiling overhead at run-time on the computer program being profiled.

Preferably, the method further comprises the steps of:
configuring the instrumentation code to record raw time measurements; and
at run time scaling a subset of the raw time measurements in response to the state of the viewing interface.

According to a second aspect of the present invention there is provided at least one computer program comprising program instructions for causing at least one computer to perform the method according to the first aspect.

According to a third aspect of the present invention there is provided a profiler configured to perform the method according to the first aspect.

According to a fourth aspect of the present invention there is provided at least one computer program comprising program instructions which, when loaded into a computer, constitute the profiler according to the third aspect.

Preferably the at least one computer programs are embodied on a recording medium or read-only memory, stored in at least one computer memory, or carried on an electrical carrier signal.

The present invention will now be described by way of example only with reference to the accompanying Figures, in which:

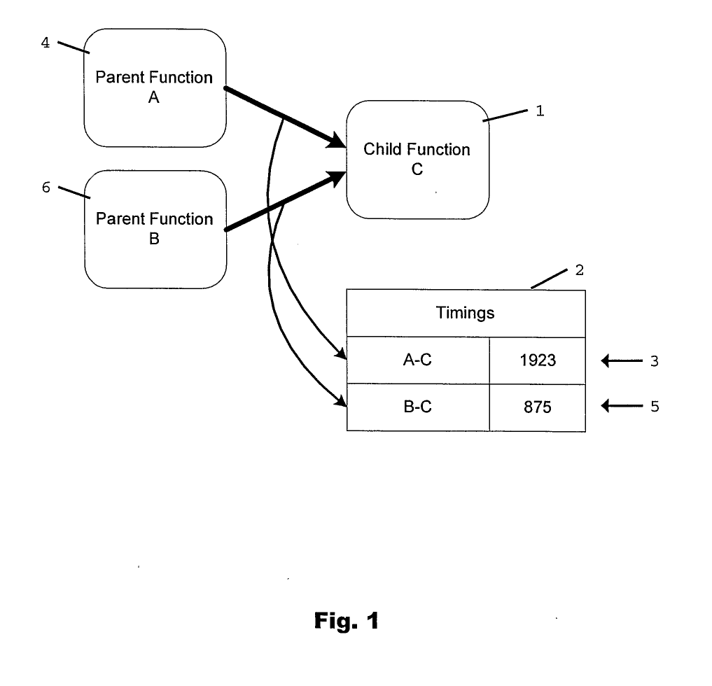

FIG. 1 illustrates, in schematic form, timing storage for each combination of parent and child function;

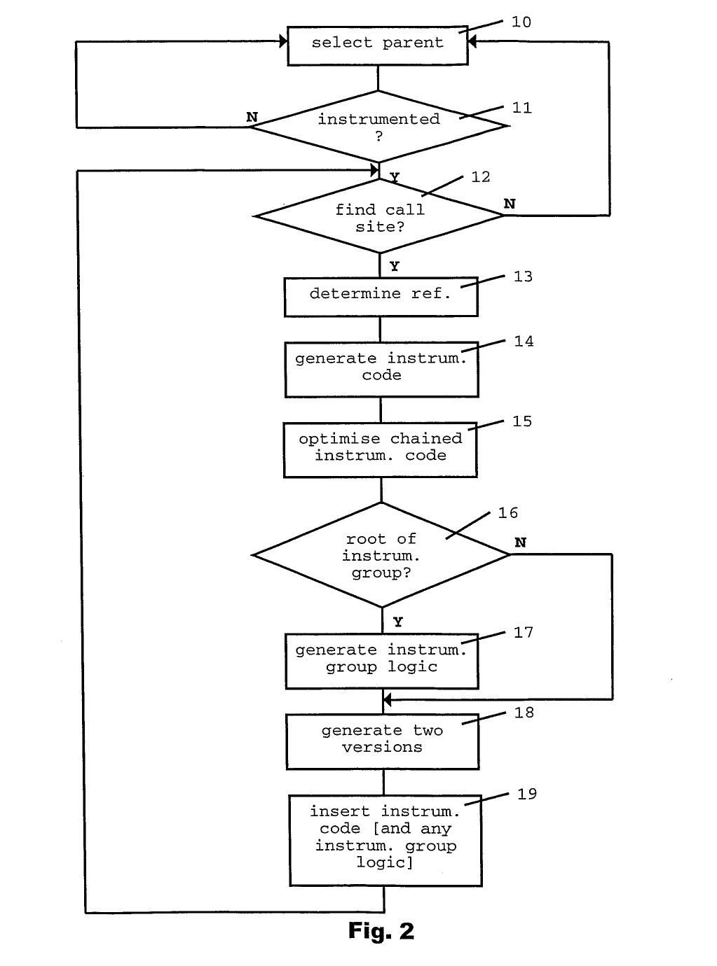

FIG. 2 illustrates, in schematic form, source code instrumentation in accordance with an embodiment of the present invention; and

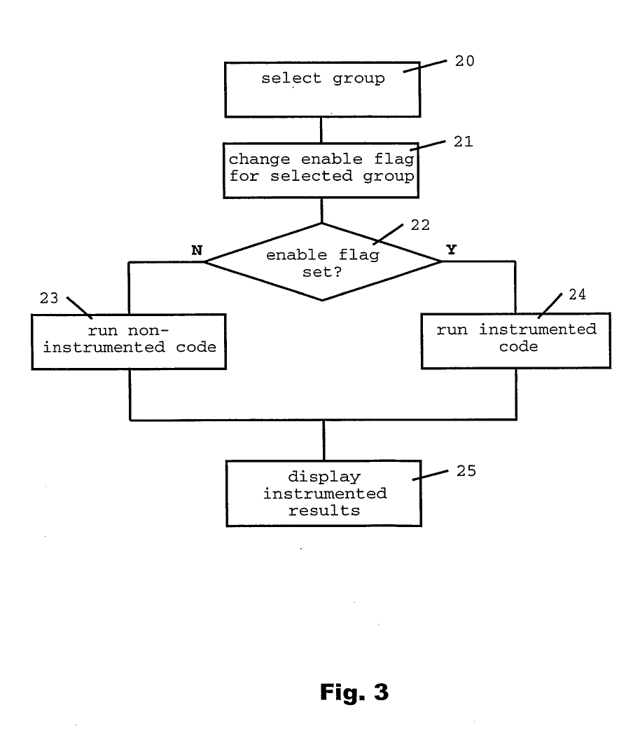

FIG. 3 illustrates, in schematic form, runtime switching of instrumentation in accordance with an embodiment of the present invention.

Embodiments of the present invention provide an instrumentation scheme, which uses compile-time metaprogramming to perform source code instrumentation of a program.

A very simple example of a prior art source code instrumented function is presented below:

```
void AFunction( )
{
      // Profiler-injected code
      Profiler_RecordEntry(“AFunction”);
      // Normal function code
      ...
      // Profiler-injected code
      Profiler_RecordExit(“AFunction”);
}
```

The choice of a source code instrumentation scheme immediately eliminates virtually all deployment issues. Since the profiling engine and instrumentation routines are built into the source code, the profiler will essentially be deployed for free by the target compiler. The only platform-specific work that is required is the creation of a routine to read the target system's clock, which is relatively trivial.

The use of an instrumentation scheme also means that we can be assured of accurate and complete results. However, there still remains the issue of performance, and the related issues affecting real-time operation.

In order to bring the performance of an instrumenting profiler up to (and beyond) the level of performance achieved by a sampling profiler, we first need to consider why sampling profilers are generally significantly less expensive in practice.

The differences are:
Cheaper operations at run time—Sampling profilers don't need to do anywhere near as much work in each timing operation.
Fewer operations—Sampling profilers tend to result in a much smaller number of timing operations.

The present invention targets both differences, as will be discussed below, each in turn.

The reason sampling profilers have cheaper timing operations at run time is that they have very little to do. A very simple sampling profiler only has to store the program counter onto the end of a buffer at each operation. A more complete version, which works with multiple threads and processes, would also have to determine the current thread and process, and store these as well, but this is still a fairly small amount of work in most cases.

By comparison, as mentioned above, an instrumenting profiler has to do the following at run time:
Obtain the current time.
Determine which parent function called the current function.
Create/find a storage slot which is unique to this combination of function and parent function.

The last two steps are required in order to store separate timings for each combination of parent and child function (for the purposes of generating the call graph), as shown in FIG. 1, that illustrates unique timing storage for each combination of parent and child function.

With reference to FIG. 1, two sets of timing records for function C 1 are stored in a timing table 2, one record 3 for when it is called by parent function A 4 and another record 5 when it is called by parent function B6.

The expensive part of this step is in determining at run time which slot to use for the parent-child combination.

The following piece of code illustrates the problem when profiling calls that directly reference a timing slot are placed at the start and end of the function being called:

```
void Function_C( )
{
      Profiler_RecordEntry(65);
      ...
      Profiler_RecordExit(65);
}
```

In this example, the call to the profiler record functions (which are only shown as functions for illustrative purposes—they are actually typically inlined code) uses a predetermined slot number (65), which happens to be the slot number for the A-C function combination. The problem with this is that if we also wish to record the B-C function combination, we'd need another copy of Function_C with that combination's slot number. This is rather wasteful, especially if Function_C is large.

According to the present invention, the profiler record calls are instead placed around the call sites in the parent functions (i.e. in this embodiment inside Function_A and Function_B):

```
void Function_A( )
{
      ...
      Profiler_RecordEntry(65);
      Function_C( );
      Profiler_RecordExit(65);
      ...
}
void Function_B( )
{
      ...
      Profiler_RecordEntry(143);
      Function_C( );
      Profiler_RecordExit(143);
      ...
}
```

Now we have a unique pair of profiler record calls for each call to Function_C, one from Function_A and one from Function_B, each with its own unique slot number, and nothing being calculated at runtime.

Thus, the source code instrumentation of an embodiment of the present invention pre-calculates almost every parent-child call path in the entire program, and injects code which uses the correct timing slot, without having to perform any calculations at runtime.

An advantage of this approach is that the resulting timings take into account the time taken to actually call the function. The prior art approach loses this information, which can be useful when trying to determine if a function should be inlined in order to improve program performance.

The use of call site timings opens up a further opportunity for improving the performance of instrumented profiling. Since code commonly consists of a sequence of function calls separated by varying amounts of logic, it stands to reason that many sections of instrumented code will consist of sequences of back-to-back timed function calls, as shown in the example below:

```
void FunctionA( )
{
      profiler_RecordEntry(65);
      Function_B( );
      Profiler_RecordExit(65);
      Profiler_RecordEntry(33);
      Function_C( );
      Profiler_RecordExit(33);
      Profiler_RecordEntry(134);
      Function_D( );
      Profiler_RecordExit(134);
      Profiler_RecordEntry(11);
      Function_E( );
      Profiler_RecordExit(11);
}
```

Each of the profiler record steps needs to obtain the system clock value, which is a relatively expensive operation compared to the rest of the step, especially now that we have eliminated the parent-child slot calculation overhead.

Looking at the example code, we see that the RecordExit call at the end of one function call is immediately followed by a RecordEntry call for the following call (for all functions except the last one). Since there is no appreciable time difference between adjacent RecordExit and RecordEntry calls, it would be sufficient to use the recorded time value from the RecordExit call for the next RecordEntry call.

In fact, in cases where there is some logic in-between two function calls, it may also be acceptable to assume that no appreciable time has elapsed between them.

The following code illustrates a sequence of function calls separated by a small amount of logic:

```
void FunctionA( )
{
      bool b = Function_B( );
      if(b)
          Function_C( );
      Function_D( );
}
```

When instrumented according to the present invention, the following chained sequence of profiled function calls may be obtained, with exit times being reused for subsequent entry times:

```
void FunctionA( )
{
      unsigned int time;
      Profiler_RecordEntry(65);
      bool b = Function_B( );
      time = Profiler_RecordExit(65);
      if(b)
      {
          Profiler_RecordEntry(33, time);
          Function_C( );
          time = Profiler_RecordExit(33);
      }
      Profiler_RecordEntry(76, time);
      Function_D( );
      Profiler_RecordExit(76);
}
```

As we can see from the code, there is now a version of RecordEntry which accepts a time value to use instead of querying the system clock again. It is used on two occasions even in this small example, one of which allows a small amount of logic in between two successive function calls.

The amount of separating logic which should be accepted before two function calls are considered to have differing enter/exit times is open to debate. The debate may be avoided by giving the user control over the accepted amount.

So far we have shown the RecordEntry and RecordExit calls as function calls but, as we have stated, they are not required to be implemented as function calls at all, but may be implemented as directly inlined code fragments.

The standard entry code fragment looks something like the following (assuming a parent-child slot number of 65):

timeSlot[65]+=GetSystemClock( );
And the corresponding exit code fragment looks like this:
timeSlot[65]-=GetSystemClock( );

Note that we avoid having to store an intermediate time in order to calculate the difference between the entry and exit times, by simply adding then subtracting the entire clock value, thanks to the associative property of addition. This also holds true even if slot 65 is used again in-between these two lines of code (e.g. in a recursive function).

If we have a chained exit-entry pair as described above, we have something like the following:
unsigned int_stopTime_{—}005=GetSystemClock( )
timeSlot[65]−=_stopTime_{—}005;
timeslot[152]+=_stopTime_{—}005;

The variable “_stopTime_{—}005” is a generated variable which is guaranteed to be unique within the current program scope. Also, rather than using a unique variable for every chained pair, we re-use them where possible; in most cases, only one is actually required.

In these examples, we still have an apparent function call, called GetSystemClock( ). This call will also be directly inlined into the code, although the exact code used will vary from system to system.

The following example shows the entry code fragment as it might appear on a system with an Intel x86 CPU, with the system clock being sampled inline using assembly language and the RDTSC (ReaD Time Stamp Counter) instruction:

```
  int64 _time;
  asm
{
      rdtsc
      mov esi, _time
      mov [esi ], eax
      mov [esi+4], edx
}
timeSlot[65] += _time;
```

As we can see, this is a fairly short sequence of code. The assembly instructions are all relatively quick, so the presence of this sequence of code at the start and end of each function call will have the minimal possible impact on the program's performance.

As we have seen from the x86 sample code, the cost of the entry/exit sequences is kept to an absolute minimum, which helps to minimise the profiler's performance impact.

Unfortunately, the values returned from the system clock are rarely directly useful for calculating program timings.

The RDTSC instruction on Intel x86 processors, for example, returns the current time in terms of clock ticks, but the number of clock ticks which corresponds to, say, one second of real time, will depend on the clock rate of the CPU. The same kind of representational difference occurs on most systems.

The standard approach for solving this issue is to determine, one way or another, how many clock units corresponds to one second (or some other, standard unit of time) and then use this relationship to determine a multiplier value with which to convert clock units into time units. The multiplier value normally only needs to be calculated once, but the actual multiplication needs to be done for every clock value.

Now, adding one extra multiplication to the entry/exit sequence may not sound like a major problem, but unfortunately it isn't quite as simple as it sounds. The conversion process rarely consists of a single multiplication instruction, and our goal is to reduce the cost of these operations as much as possible.

The solution to this is to defer the conversion until a time when we actually need the value in standard time units, which is far less often than the total number of entry/exit calls taking place while the program is running.

The basic premise behind this is that the only situation in which we need the timings in standard time units is when they will be presented to a human. Since a human is incapable of reading many millions of timings all at once, we only need to convert into standard units for the small number of timings that the user is viewing at any given time.

Now, it is possible that the user may be looking at a top-level function which contains an aggregate of timings for many smaller functions, but in such cases we merely need to perform the time conversion on the aggregate total, not on each individual timing value. The same goes for percentages: when we wish to calculate a function's percentage of the total time, we can just as easily perform this calculation in clock time.

By minimising our time conversion requirements in this manner, we keep the entry/exit code sequences as short as possible.

As described, the approach of the present invention manages to record the timings for complete parent-child function combinations in the minimal number of instructions. In particular, the number of instructions used by the approach of the present invention is now less than that typically used by sampling profilers, which don't even catch parent-child relationships.

However, this in itself may not be quite enough to bring our profiler's performance up to that of sampling profilers, since they generally require fewer operations, which is discussed below.

Sampling profilers typically require fewer timing operations than instrumenting profilers because they only need to be set to run at a frequency which gives statistically useful results. This frequency is normally somewhat less than the frequency of timing operations we would see from instrumenting profilers which record every function entry/exit.

Although this strategy works fairly well up to a point, it results in the absolute accuracy of sampling profilers being significantly lower than that of instrumenting profilers. The bulk of the accuracy loss is in functions which are not called very often, so this is a reasonable trade-off, since these functions will not contribute significantly to the program's overall performance profile.

What instrumenting profilers can do is limit the scope of program coverage that they measure: the less they measure, the less performance impact they have. Existing instrumenting profilers already do this to some extent, but this simply consists of allowing the user to manually exclude specific modules and/or functions. This does increase their usability, but a more automatic approach is desirable.

The present invention provides a simple, intuitive way to control the profiler's scope, which allows programmers to specify whether a function and all of its descendents (functions which it calls and functions which they call, and so on) should be instrumented (or not instrumented, if that is more convenient).

There's no practical way for a binary instrumentation scheme to do this, but the metaprogramming-enabled source instrumentation scheme of the present invention records enough program information to achieve this very effectively. And since it is metaprogramming-based, it also allows programmers to specify which functions to instrument directly in their source code.

Another very useful feature of the approach of the present invention is that programmers can specify how many levels deep an enable/disable switch is valid for. This allows them to easily specify that they wish to see the overall profile of some subsystem, without paying the cost of profiling the lower-level details, by only enabling instrumentation for the first few levels of function calls. Alternatively, the programmer may only wish to see the lower-level functions.

Finally, to make the programmer's life as easy as possible, our approach allows multiple functions to be grouped and enabled or disabled together. Programmers can use this to build a set of overall profiling strategies which they can easily switch between.

For example, a game developer might have the following groups:
The main, top-level functions and 3 levels of function below that.
The entire physics subsystem.
The main functions in the graphics subsystem.
The low-level functions in the graphics subsystem.
Some combination of the above groups.

This flexible model actually matches what experienced developers naturally tend to do when they are profiling and optimising a program. They start by looking at the program's overall performance profile and use this to judge which areas to concentrate their next phase of optimisation on. When they have chosen a particular area, they tend to concentrate, or drill-down, on that area for quite some time, before coming back up to the overall viewpoint and seeing what effect their changes have had on the overall performance of their program.

With our approach, they can do this with relative ease, and without sacrificing accuracy or performance. They do have to put in a little effort, but it's a modest amount of effort for a fairly significant payback.

A downside to this partial instrumentation by level of the source code is that switching instrumentation groups on and off can cause a significant amount of recompilation.

For experienced programmers who use a methodical, drill-down approach, this is not a major issue, but not all programmers are patient and methodical, so we have further extended our approach to effectively eliminate compile-time switching entirely.

The present invention allows programmers and unskilled users of the profiling viewer to switch instrumentation groups on and off at runtime.

It achieves this by generating two versions of every function in the program, one with instrumentation, and one without. The functions at the root of every instrumentation group are also given logic to decide which set of child functions to call, based on an enable/disable flag for that root function.

As an example, consider the following function, which will be a root instrumentation function:

```
void Function_A( )
{
      Function_B( );
      Function_C( );
}
```

Functions B and C will have two versions generated for them, as follows:
Function_B1 (instrumented)
Function_B2 (non-instrumented)
Function_C1 (instrumented)
Function_C2 (non-instrumented)

Functions B and C may call other functions. Two versions will be generated for each of these, and so on, for all their descendents.

Since any given function can be reached through a number of paths, the generation of multiple copies of any function may to go through a function registry which avoids the generation of functions which have already been generated.

Coming back to the example, Function_A will then be modified to look something like the following expanded version of a root instrumentation function, showing both profiled and non-profiled execution paths:

```
void Function_A( )
{
      if(profileEnabled[17])
      {
          Profiler_RecordEntry(65);
          Function_B1( );
          Profiler_RecordExit(65);
          Profiler_RecordEntry(23);
          Function_C1( );
          Profiler_RecordExit(23);
      }
      else
      {
          Function_B2( );
          Function_C2( );
      }
}
```

The profileEnabled[17] value is a boolean value which holds true if root function 17 (which corresponds to Function_A in this example) should be profiled, and false if not.

Our new Function_A then takes one of two routes, depending on whether or not profiling is enabled for it. Both routes are identical from a logical point of view (in this case, they both call Function_B followed by Function_C), but one route performs timing operations around each call and calls the instrumented versions of those functions, whereas the other route does not.

Now, since Function_B1 and Function_C1 are both instrumented, they will time their function calls and call instrumented versions of their child functions, and so on.

Function_B2 and Function_C2, on the other hand, will not time their function calls and will call the non-instrumented versions of their child functions, and so on.

With this setup, we can easily switch the entire tree of function calls under Function_A on and off at runtime, simply by changing the value of profileEnabled[17].

This technique can be further extended to support depth control. As mentioned earlier, depth control allows the programmer to specify how many levels an enable/disable switch is valid for. With the simple example just given, switches will naturally impact all levels below them, which is undesirable if the programmer has specified a depth limit.

However, we can trace the function calls down by the specified number of levels, and automatically inject runtime decision points in those functions. This does have the effect of making depth-controlled switches more expensive than normal switches, but since depth-controlled switches are used to reduce the overall number of instrumented functions, it is usually a profitable trade-off.

So far, we have disclosed the provision of runtime switching for instrumentation groups which the programmer has created manually.

Using the metaprogramming-based approach of the present invention, it is also possible for the instrumentation system to generate an automatic distribution of instrumentation groups, based on the overall call graph of the code. These groups can then be automatically switched on and off, based on the specific results that the user is viewing at any given time.

This is an extremely attractive quality, because it provides us with a mode of operation which requires no effort on the part of the programmer, yet manages to provide very accurate, complete timing results in real-time.

It could be argued that this is the only mode of operation actually required, since it appears to achieve the same goals as the manually-controlled mode. However, this mode does not work for non-real-time profiles, since there is no corresponding interface for the user to influence which instrumentation groups to enable, so the manually-controlled mode is still required for that purpose. It is also possible that users will find the manually-controlled mode more natural to use in practice.

As we have shown, the present invention manages to significantly reduce the number of required profiling operations being run at any one time, without compromising accuracy and without placing a significant burden on the programmer.

When combined with the approach to achieving cheaper operations, this results in a profiling system which is faster and more accurate than a sampling profiler, but which has all the advantages of an instrumenting profiler (e.g. capturing call graph information).

A large part of enabling useful, runtime operation of a profiling system involves making the timing capture process perform well enough that it does not impact a program's runtime performance too badly, such that the user can operate the program while viewing immediate timing results.

The remaining part involves being able to collate all the results into a meaningful display, again without a significant performance impact.

The data generated by the instrumented timing approach of the present invention is very amenable to a quick collation process, and therefore it is highly suitable for real-time use.

Unlike a sampling profiler, the instrumentation approach of the present invention already has all the function timings directly associated with each function. Since we record each parent-child timing separately, we do have to sum a number of times to get a total time for each function, but since we have pre-determined our time counters at compile time, this is a simple matter of summing a series of values in a column, which is very quick. It is also highly typical for the average number of call paths per function to tend towards a very small number over an entire program, so only one or two column values are relevant in most cases.

Also, since the timing data is hierarchical, and the user will tend to view a subset of the entire data-set at any one time, we can delay both collation and sorting of data until the user actually tries to view that data. Since the user can only view a limited number of timings at any one time (due to limited screen space), this helps to keep the amount of collation and sorting to a minimum.

The result of all this is that the basic real-time display process has a minimal impact on running performance. This allows us to go even further, by displaying useful, secondary information, such as graphs of function and subsystem performance over time, and separated timings from different incoming call paths.

An embodiment of the present invention will now be described, incorporating many of the features disclosed above.

With reference to FIG. 2, a flow chart of source code instrumentation is illustrated. A parent function (or procedure, module, method, etc.) is selected 10 and its level in the call hierarchy is determined. If instrumentation has been specified 11 as required, the function is parsed to find 12 the call site of a child function. If none is found then the next parent is selected.

For the found call site, the reference to a timing record unique to the combination of the parent and child functions is determined 13 (or unique to the parent function and specific call site, in the case of more than one call to a child in the same parent). The instrumentation code is generated 14 to have a function call or inline code that records an entry time into the child function and an exit time from the child function. In the case of a chain of call sites, the instrumentation code is optimised 15 to use the exit time of a previous call site as the entry time of the call site.

If the current function is the root of an instruction group 16, instrumentation group logic is generated 17 to decide which child function should be called, either one with instrumentation or one without instrumentation, based on an enable/disable flag for the root function.

Two versions of the child function are generated 18, one instrumented and the other not, and the instrumentation code is inserted 19 around the call site in the instrumented version, along with any instrumentation group logic that has been generated.

The process of steps 12-19 in FIG. 2 is repeated for all call sites in the source code of the current parent function. The child functions may be processed themselves as parent functions either in order through the source code files, or as they are encountered at call sites to them in the source code.

FIG. 3 illustrates run-time switching of instrumentation. With reference to FIG. 3, a user is provided with a viewing interface for viewing the instrumentation results from a program that has been instrumented according to the present invention. The viewing program allows the user to select 20 a group of functions for display, including by drilling down in the call graph hierarchy. In response to the selection of the group the enable flag is changed 21 for the selected group. The changing of the enable flag causes the compiled instrumentation group logic in the instrumented program to run either non-instrumented code 23 or instrumented code 24. Therefore, the program is instrumented based on the user interaction. Finally, the viewing interface displays 25 the instrumented results. However, because the instrumentation is only enabled for the currently viewed results, the remainder of the program is uninstrumented and runs more efficiently, with less performance overhead from the instrumentation. The groups may alternatively selected heuristically by software.

In a performance profiling tool that is suitable for game development, the major requirements are:
Accuracy—Capture as much timing information as possible, with as much accuracy as possible.
Completeness—Capture all call graph information.
Performance—Minimal intrusion on program running speed (and thus measurement of asynchronous hardware).
Deployment—Can be deployed on a wide range of systems.
Real-time Operation—Timing results are available for display while the program is running.

The main trade-off profilers have to make is between accuracy and completeness versus performance. The present invention eliminates this trade-off to some extent, or even completely, to give an accurate and complete hierarchical timing solution suitable for real-time use, for both application and game development.

The profiler methodology of the present invention can also profile multi-threaded software, running on one or more processors.

Furthermore, the present invention is significantly easier to deploy than existing profiling systems, making it a suitable candidate for use on game consoles.

Further modifications and improvements may be added without departing from the scope of the invention herein described.

What is claimed is:

1. A method of instrumentation of a child function in a computer program, wherein the child function is called by a parent function, the method comprising the step of inserting instrumentation code around a call site of the child function in the parent function.

2. The method of claim 1 further comprising the steps of:
determining a reference to an instrumentation record unique to the combination of the call site and the child function; and
configuring the instrumentation code to use the reference for the instrumentation of the child function.

3. The method of claim 2, wherein the reference refers to the location of the instrumentation record in a table.

4. The method of claim 2, wherein the instrumentation record comprises a timing record.

5. The method of claim 1, further comprising the step of optimising the instrumentation code to use the exit time of a preceding call site in the parent function as the entry time of the call site.

6. The method of claim 1, further comprising the step of inserting the instrumentation code depending on the level in the call hierarchy of the child function.

7. The method of claim 1, further comprising the step of configuring the instrumentation code such that its execution at run time of the computer program depends on the state of an enable flag.

8. The method of claim 1, further comprising the step of generating two versions of the child function, one being instrumented and other being non-instrumented.

9. The method of claim 8, wherein the step of configuring the instrumentation code such that its execution at run time of the computer program depends on the status of an enable flag further comprises the step of configuring the instrumentation code to call either the instrumented version of the child function or the un-instrumented version of the child function, depending on the state of the enable flag.

10. The method of claim 7, further comprising the steps of:
configuring a viewing interface to view results of the instrumentation of the computer program; and
setting the enable flag in response to the state of the viewing interface.

11. The method of claim 1 further comprising the steps of:
configuring the instrumentation code to record raw time measurements; and
at run time scaling a subset of the raw time measurements in response to the state of the viewing interface.

12. Computer readable program means comprising program instructions for causing at least one computer to perform the method of claim 1.

13. The computer readable program means of claim 12 embodied on a recording medium or read-only memory, stored in at least one computer memory, or carried on an electrical carrier signal.

14. A profiler configured to perform the method of claim 1.

15. (canceled)

16. The computer readable program means of claim 1 embodied on one of a recording medium, a read-only memory, a computer memory element, and an electrical carrier signal.
